(19) United States
(12) Patent Application Publication
(10) Pub. No.: US 2024/0149790 A1
(43) Pub. Date: May 9, 2024

(54) Indicating the Travel Direction of a Motor Vehicle

(71) Applicant: Bayerische Motoren Werke Aktiengesellschaft, Muenchen (DE)

(72) Inventor: Olivier COUSIGNE, Wielenbach (DE)

(21) Appl. No.: 18/275,259

(22) PCT Filed: Jan. 20, 2022
(86) PCT No.: PCT/EP2022/051200

§ 371 Date: Aug. 1, 2023

(30) Foreign Application Priority Data
Mar. 9, 2021 (DE) 10 2021 105 654.3

(51) Int. Cl. B60Q 9/00; B60W 50/14; B60W 50/16

(52) U.S. Cl. CPC B60Q 9/00; B60W 50/16; B60W 2050/143; B60Y 2400/902

(57) ABSTRACT

A method for indicating the travel direction of a motor vehicle includes: sensing that a travel-direction indicating device of the motor vehicle is actuated, wherein the travel-direction indicating device, when actuated, causes the output of a first acoustic signal at a first volume in order to accordingly inform an occupant of the motor vehicle, such as, in particular, the driver of the motor vehicle. For the user-friendly provision of a less distracting method for indicating the travel direction of a motor vehicle, the method includes: sensing, by way of a vehicle-movement sensing device, that the motor vehicle has come to a standstill from a moving state, more particularly a rolling state, and, during the standstill of the motor vehicle, the travel-direction indicating device causes a second acoustic signal to be output instead of the first acoustic signal, the second acoustic signal differing from the first acoustic signal by virtue of the lower volume.

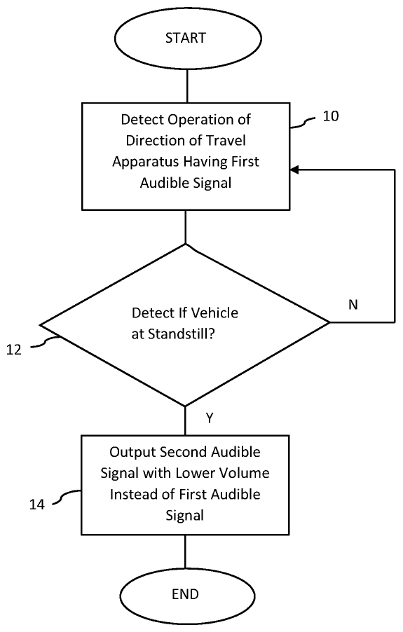

### BACKGROUND AND SUMMARY

The invention relates to a method for indicating the direction of travel of a motor vehicle, in particular a two- or four-wheeled motor vehicle.

The sound volume of known direction-of-travel indicators or known blinkers of motor vehicles is chosen such that the direction-of-travel indicator can easily be heard even given loud ambient noise, e.g. while traveling and/or while the motor vehicle has its engine running.

When ambient sounds are quiet, the known direction-of-travel indicators or blinkers of motor vehicles are often found to be irritating and therefore distracting.

The object of the invention is, in particular, a method for indicating the direction of travel of a motor vehicle that is found to be less distracting.

This object is achieved in particular by a method according to the independent patent claim. Advantageous configurations of the invention are the subject of the dependent patent claims.

The invention proceeds from a method for indicating the direction of travel of a motor vehicle comprising the following step: detecting that a direction-of-travel indicator apparatus of the motor vehicle has been operated, the direction-of-travel indicator apparatus bringing about output of a first audible signal at a first volume to appropriately inform an occupant of the motor vehicle when it is operated, such as in particular the driver of the motor vehicle.

According to the invention, there is provision for the following steps:
detecting, by way of a vehicle motion detection apparatus, that the motor vehicle has come to a standstill from a moving state, in particular a rolling state; and
when the motor vehicle is at a standstill, the direction-of-travel indicator apparatus brings about output of a second audible signal instead of the first audible signal, said second audible signal differing from the first audible signal at least by virtue of having a lower volume.

### BRIEF DESCRIPTION OF THE DRAWING

The FIGURE is a flowchart of an exemplary method according to the invention.

### DETAILED DESCRIPTION OF THE DRAWING

Referring to the FIGURE, a method for indicating a travel direction of a motor vehicle includes steps of: detecting/sensing operation of a direction-of-travel indicator apparatus of the motor vehicle, the direction-of-travel indicator apparatus bringing about output of a first audible signal at a first volume to appropriately inform an occupant of the motor vehicle when it is being operated (step 10); detecting, by way of a vehicle motion detection apparatus, that the motor vehicle has come to a standstill from a moving state (step 12); and when the motor vehicle is at a standstill (Y), the direction-of-travel indicator apparatus outputs a second audible signal instead of the first audible signal, said second audible signal differing from said first audible signal at least by having a lower volume (step 14).

In known vehicles, the first audible signal consists of a “click-clack” of constant volume from a blinker and is chosen to be loud enough for it still to be easily heard even given loud ambient noise, for example while traveling and/or while the engine is running. The volume of the blinker is found to be disagreeable, in particular, when the engine or internal combustion engine of the motor vehicle is switched off by a start-stop function of the motor vehicle while stationary at traffic lights. The loud “click-clack” is then particularly audible and has the effect of being irritating and therefore distracting.

The vehicle motion detection apparatus according to the invention detects that the motor vehicle has come to a standstill from a moving state, and the direction-of-travel indicator apparatus according to the invention brings about output of a second audible signal instead of the first audible signal. As the second audible signal differs from the first audible signal at least by virtue of its lower volume, the disagreeably loud “click-clack” is eliminated and is replaced by a much quieter “click-clack”, for example.

It goes without saying that a different first and/or second audible signal can also replace the “click-clack” completely or in part.

A difference between the first and second audible signals can be, for example, that the second audible signal is only half as loud as the first audible signal.

There can also be provision for a volume measuring apparatus that, during operation of the motor vehicle, measures how many decibels the first audible signal is above the volume in the vehicle. When the motor vehicle is at a standstill, this volume measuring apparatus can then measure what volume there is in the stationary vehicle when the first signal is switched off. The volume measuring apparatus can then influence the volume of the second audible signal in such a way that it is above the volume of the vehicle surroundings in the vehicle by the same decibel value. That is to say, that the occupants of the vehicle perceive the volume of the second audible signal to be just as loud as the first audible signal when the vehicle interior is quieter.

It goes without saying that the volume balance between the first and second audible signals can also be chosen in a different or slightly different way.

In a first configuration of the method according to the invention, there is provision for the direction-of-travel indicator apparatus to bring about mechanical vibration of a human-machine interface in addition to output of the second audible signal or as an alternative to output of the second audible signal.

In accordance with one development of the method according to the invention, there is provision for the human-machine interface to be formed by a vibrating steering apparatus of the motor vehicle.

In another development of the method according to the invention, there is provision for the human-machine interface to be formed by a seating or support area of a seat for the occupants of the motor vehicle.

The mechanical vibration of the human-machine interface according to the invention additionally and/or alternatively provides the driver and/or one or more occupants with the information that the motor vehicle is (soon) leaving its lane or turning off. This is advantageous in particular if the motor vehicle drives autonomously or semi-autonomously, because the occupant or occupants is/are intuitively advised that the direction of travel of the motor vehicle will shortly change. This measure is suitable in particular for conveying a safe riding experience to the occupants of the motor vehicle.

In one development of the method according to the invention, there is provision for the vehicle motion detection apparatus to detect that the motor vehicle is in a moving state again, in particular a rolling state, and the vehicle motion detection apparatus detects that the direction-of-travel indicator apparatus of the motor vehicle has been operated and causes output of the first audible signal again instead of the second audible signal.

This measure according to the invention ensures that the occupants of the motor vehicle can easily hear the direction-of-travel indicator again at the accompanying higher volume while riding, for example when starting off and turning at traffic lights that were previously on red and then changed to green.

In one configuration of the method according to the invention, there is provision for the direction-of-travel indicator apparatus to bring about shutdown of the mechanical vibration of the human-machine interface.

In accordance with one embodiment of the method according to the invention, there is provision for the direction-of-travel indicator apparatus to bring about output of the first audible signal instead of the second audible signal if the internal combustion engine and/or electric motor of the motor vehicle starts up again.

These measures according to the invention also ensure that the occupants of the motor vehicle can easily hear the direction-of-travel indicator again at the accompanying higher volume while riding.

The invention also facilitates an advantageous direction-of-travel indicator apparatus of a motor vehicle in accordance with a method according to the invention.

Furthermore, the invention facilitates the provision of a motor vehicle that is controlled autonomously or manually by a driver, in accordance with a method according to the invention.

Finally, the invention facilitates a computer program product for controlling at least one processor that brings about execution of a method according to the invention.

1.-10. (canceled)

11. A method for indicating a direction of travel of a motor vehicle, comprising:
detecting operation of a direction-of-travel indicator apparatus of the motor vehicle, the direction-of-travel indicator apparatus causing an output of a first audible signal at a first volume to appropriately inform an occupant of the motor vehicle when it is being operated;
detecting, by way of a vehicle motion detection apparatus, that the motor vehicle has come to a standstill from a moving state; and
when the motor vehicle is at a standstill, the direction-of-travel indicator apparatus outputs a second audible signal instead of the first audible signal, said second audible signal differing from said first audible signal at least by having a lower volume.

12. The method for indicating the direction of travel of a motor vehicle according to claim 11, wherein
the direction-of-travel indicator apparatus brings about mechanical vibration of a human-machine interface in addition to the output of the second audible signal or as an alternative to the output of the second audible signal.

13. The method for indicating the direction of travel of a motor vehicle according to claim 12, wherein
the human-machine interface is formed by a vibrating steering apparatus of the motor vehicle.

14. The method for indicating the direction of travel of a motor vehicle according to claim 12, wherein
the human-machine interface is formed by a seating or support area of a seat for an occupant of the motor vehicle.

15. The method for indicating the direction of travel of a motor vehicle according to claim 11, wherein
the vehicle motion detection apparatus detects that the motor vehicle is in a moving state again, and
the vehicle motion detection apparatus detects that the direction-of-travel indicator apparatus of the motor vehicle has been operated and causes output of the first audible signal instead of the second audible signal.

16. The method for indicating the direction of travel of a motor vehicle according to claim 12, wherein
the vehicle motion detection apparatus detects that the motor vehicle is in a moving state again, and
the vehicle motion detection apparatus detects that the direction-of-travel indicator apparatus of the motor vehicle has been operated and causes output of the first audible signal instead of the second audible signal.

17. The method for indicating the direction of travel of a motor vehicle according to claim 16, wherein
the direction-of-travel indicator apparatus causes a shutdown of the mechanical vibration of the human machine interface.

18. The method for indicating the direction of travel of a motor vehicle according to claim 11, wherein
the direction-of-travel indicator apparatus causes the output of the first audible signal instead of the second audible signal if an internal combustion engine and/or an electric motor of the motor vehicle starts up again.

19. The method for indicating the direction of travel of a motor vehicle according to claim 11, wherein the moving state is a rolling state of the motor vehicle.

20. A direction-of-travel-indicator apparatus of a motor vehicle, comprising:
one or more processors and associated memory operatively configured to:
detect operation of a direction-of-travel indicator apparatus of the motor vehicle, the direction-of-travel indicator apparatus causing an output of a first audible signal at a first volume to appropriately inform an occupant of the motor vehicle when it is being operated;
detect, by way of a vehicle motion detection apparatus, that the motor vehicle has come to a standstill from a moving state; and
when the motor vehicle is at a standstill, the direction-of-travel indicator apparatus outputs a second audible signal instead of the first audible signal, said second audible signal differing from said first audible signal at least by having a lower volume.

21. A motor vehicle, comprising:
a direction-of-travel indicator apparatus according to claim 20,
wherein the motor vehicle is a two- or four-wheeled motor vehicle that is controlled autonomously, semi-autonomously, or manually by a driver.

22. A computer product comprising a non-transitory computer readable medium having stored thereon program code that, when executed by at least one processor, carries out the acts of:
detecting operation of a direction-of-travel indicator apparatus of the motor vehicle, the direction-of-travel indicator apparatus causing an output of a first audible signal at a first volume to appropriately inform an occupant of the motor vehicle when it is being operated;
detecting, by way of a vehicle motion detection apparatus, that the motor vehicle has come to a standstill from a moving state; and
when the motor vehicle is at a standstill, the direction-of-travel indicator apparatus outputs a second audible signal instead of the first audible signal, said second audible signal differing from said first audible signal at least by having a lower volume.
